(19) United States
(12) Patent Application Publication
(10) Pub. No.: US 2016/0170808 A1
(43) Pub. Date: Jun. 16, 2016

(54) CONTEXTUAL UTILIZATION MANAGEMENT OF APPLICATIONS IN A PERVASIVE DEVICE

(71) Applicant: International Business Machines Corporation, Armonk, NY (US)

(72) Inventors: Ulysses L. Cannon, Durham, NC (US); Ruthie D. Lyle, Durham, NC (US); Dana L. Price, Surf City, NC (US)

(21) Appl. No.: 14/572,310

(22) Filed: Dec. 16, 2014

(51) Int. Cl. G06F 9/50; H04L 29/08; G06F 3/0481

(52) U.S. Cl. CPC G06F 9/5055; G06F 3/04817; H04L 67/10; H04L 67/34

(57) ABSTRACT

Embodiments of the present invention provide a method, system and computer program product for contextual application utilization management in a pervasive device. In an embodiment of the invention, a method of contextual application utilization management in a pervasive device includes annotating different applications in a pervasive device with different context associations for respectively different environmental contexts of the pervasive device. The method additionally includes activating a context mode in the pervasive device. Responsive to the activation of the context mode, a contemporaneous environmental context for the pervasive device is determined, individual ones of the different applications having associated context annotations matching the determined contemporaneous environmental context are selected, and unselected ones of the different applications are blocked from default utilization of the resources of the pervasive device while default utilization of resources of the pervasive device is permitted by the selected ones of the different applications.

### BACKGROUND OF THE INVENTION

1. Field of the Invention

The present invention relates to pervasive device user interface management and more particularly to application icon placement in a user interface of a pervasive device.

2. Description of the Related Art

Pervasive computing refers to the ability of an end user to engage in a computing process anywhere regardless of the presence of a fixed personal computer. Reliant upon mobile technologies, wireless broadband accessibility and small form factors, pervasive computing is now the dominant mode of individual computing—particularly in light of the ubiquitous presence of smart phones and tablet computing. In pervasive computing, end users access data and applications at any time at any location, sometimes without regard to Internet connectivity, through a device such as a tablet or smartphone. Locating and utilizing different applications for use in the pervasive device is as simple as accessing an “app store” or other such repository of applications, searching the repository for an application by name, category or popularity, and downloading the selected application onto the pervasive device wirelessly from over a computer communications network.

Of note, the ease in which an application can be located, retrieved and installed onto a pervasive device lends itself to the cluttering of a pervasive device with an overwhelming number of applications. To compound matters, oftentimes the manufacturer of a pervasive device preloads a multiplicity of different applications onto the pervasive device irrespective of the desirability of the pre-loaded applications by the purchasing consumer. Thus, the user interface of the pervasive device—often referred to as a “home screen”—can become overrun with application icons. Locating a particular icon of interest therefore typically requires the end user to cycle through a number of different “home screens” in order to locate a singularly desired application.

Worse yet, once executed in the memory of a pervasive device, even when obscured by a different application, an application may continue to execute consuming important computing resources of the pervasive device. Since pervasive devices infrequently reboot, it is only a matter of time before unintentionally executing applications overly consume the valuable resources of the pervasive device. The only solution at that juncture is to manually terminate application executions or reset the pervasive device. However, to the extent an application is configured to automatically load upon booting of the pervasive device, even a hard rebooting of the device will not prevent the unwanted execution of an application in the pervasive device.

### BRIEF SUMMARY OF THE INVENTION

Embodiments of the present invention address deficiencies of the art in respect to application management in a pervasive device and provide a novel and non-obvious method, system and computer program product for contextual application utilization management in a pervasive device. In an embodiment of the invention, a method of contextual application utilization management in a pervasive device includes annotating different applications in a pervasive device with different context associations for respectively different environmental contexts of the pervasive device. The method additionally includes activating a context mode in the pervasive device. Responsive to the activation of the context mode, a contemporaneous environmental context for the pervasive device is determined, individual ones of the different applications having associated context annotations matching the determined contemporaneous environmental context are selected, and unselected ones of the different applications are blocked from utilizing the resources of the pervasive device while selected ones of the different applications are permitted default utilization of the resources of the pervasive device.

In one aspect of the embodiment, the different environmental contexts of the pervasive device include a location of the pervasive device. In another aspect of the embodiment, the different environmental contexts of the pervasive device include a date or time. In yet another aspect of the embodiment, the different environmental contexts of the pervasive device include a weather condition at a location of the pervasive device. In even yet another aspect of the embodiment, the blocking of the utilization of the resources of the computing device includes blocking access to computing resources of the pervasive device. Alternatively, the blocking of the utilization of the resources of the computing device includes removing access to icons for the unselected ones of the different applications in a user interface of the pervasive device.

In another embodiment of the invention, a pervasive device data processing system is configured for contextual application utilization management. The system includes a pervasive device that includes at least one processor coupled to memory. The system also includes a wireless network adapter adapted to transceive data in the memory wirelessly over a communications network. The system yet further includes different applications stored in persistent storage of the pervasive device and coupled to the processor and memory, each of the applications including an annotation specifying at least one environmental context. Finally, the system includes a contextual application utilization management module. The module includes program code enabled upon execution in the memory of the pervasive device to activate a context mode for the pervasive device and in response to the activation of the context mode, to determine a contemporaneous environmental context for the pervasive device, to select individual ones of the different applications having associated context annotations matching the determined contemporaneous environmental context, and to block utilization of the resources of the pervasive device by unselected ones of the different applications but to permit normal utilization of the resources of the pervasive device by selected ones of the different applications.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for contextual application utilization management in a pervasive device;

FIG. 2 is a schematic illustration of a pervasive device data processing system configured for contextual application utilization management; and,

FIG. 3 is a flow chart illustrating a process for contextual application utilization management in a pervasive device.

### DETAILED DESCRIPTION OF THE INVENTION

Embodiments of the invention provide for contextual application utilization management in a pervasive device. In accordance with an embodiment of the invention, different applications stored in a pervasive device can be associated with different environmental contexts of the pervasive device, such as its location, a current time, a current date, or a current weather condition. Thereafter, an environmental context of the pervasive device can be determined and applications with associated contexts not matching the environmental context of the pervasive device are placed in a non-visible mode whereas applications with associated contexts matching the environmental context of the pervasive device are placed in a visible mode. The visible mode permits an iconic representation of a corresponding application to be visible in a user interface for the pervasive device, and the visible mode permits default consumption of computing resources of the pervasive device. The non-visible mode obscures a display of a corresponding application and does not permit default consumption of computing resources of the pervasive device.

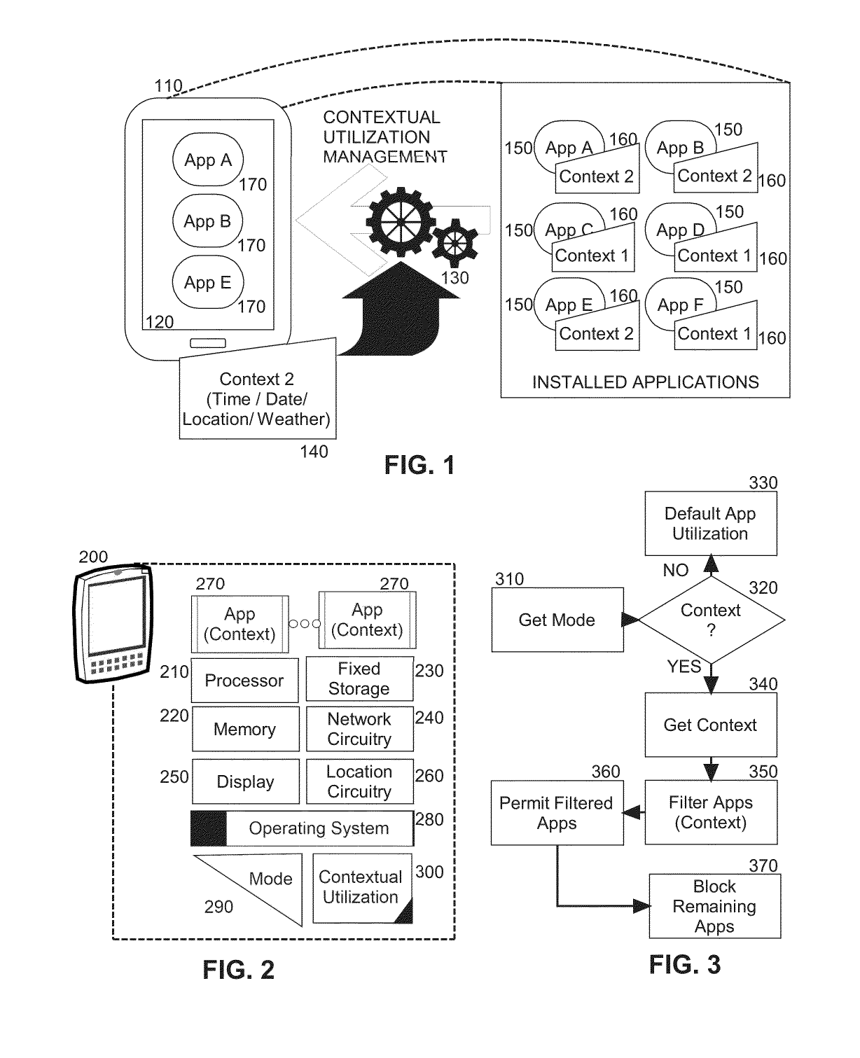

In further illustration, FIG. 1 pictorially shows a process for contextual application utilization management in a pervasive device. As shown in FIG. 1, different applications 150 can be stored in a pervasive device 110 through which each individual one of the applications 150 may be accessed through a corresponding display interface 120 of the pervasive device. Each of the applications 150 can be annotated with a context indicator 160. The context indicator 160 can indicate a context of the pervasive device in which a corresponding one of the applications 150 is to enjoy visibility within the display 120 and access to the computing resources of the pervasive device 110. For instance, the context can include a time of day, a date, a location of the pervasive device 110 or a contemporaneous weather condition in the geographic location of the pervasive device 110.

Notably, contextual utilization logic 130 can determine for the pervasive device 110 a particular context 140 of the pervasive device 110 when the pervasive device is placed into a context mode. In response to the determination of the particular context 140 the contextual utilization logic 130 can identify a filtered selection 170 of the applications 150 with corresponding context identifiers 160 matching the particular context 140 of the pervasive device 110. Thereafter, the contextual utilization logic 130 can place the filtered selection 170 of the applications 150 into a visible state in which the applications 150 of the selection 170 are visible on the display 120 and may access the computing resources of the pervasive device 110. In contrast, the applications 150 excluded from the selection 170 can be blocked by the contextual utilization logic 130 from visibility in the display 120 and from accessing the computing resources of the pervasive device 110.

Thereafter, a change in contemporaneous environmental context 140 for the pervasive device 110 can be detected. In response, the contextual utilization logic 130 again can identify a filtered selection 170 of the applications 150 with corresponding context identifiers 160 matching the changed context 140 of the pervasive device 110 and the contextual utilization logic 130 can place the filtered selection 170 of the applications 150 into a visible state in which the applications 150 of the selection 170 are visible on the display 120 and may access the computing resources of the pervasive device 110 whilst the applications 150 excluded from the selection 170 can be blocked by the contextual utilization logic 130 from visibility in the display 120 and from accessing the computing resources of the pervasive device 110.

The process described in connection with FIG. 1 can be implemented in a pervasive device data processing system. In yet further illustration, FIG. 2 schematically shows a pervasive device data processing system configured for contextual application utilization management. The system includes a pervasive device 200 such as a smart phone or tablet that includes at least one processor 210, memory 220 and fixed storage in which different applications 270 are installed and annotated with one or more context identifiers. The system also includes network circuitry 240 with which data communications can be conducted wirelessly as between the pervasive device 200 and other computing devices over a computer communications network.

Even yet further, the system can include an operating system 280 executing in the memory 210 by the processor 220 and managing access to the computing memory 220, processor 210, fixed storage 230 and network circuitry 240 of the pervasive device as well as to a display 250. The display 250 can present a user interface through which individual ones of the applications 270 when executing through the operating system 280 in the memory 220 by the processor 210 may be accessed by an end user. Finally, as an option location circuitry 260 can be coupled to the processor 210 and can be arranged to determine a contemporaneous geographic position of the pervasive device 200.

Of note, a contextual utilization module 300 can execute through the operating system 280 in the memory 220 by the processor 210. The module 300 includes program code enabled upon execution by the processor 210 to respond to a context mode 290 established for the pervasive device 200 by determining an environmental context of the pervasive device 200 and filtering the applications 270 to a selection including only those of the applications 270 annotated with a context identifier matching the determined environmental context. The program code is further enabled to place the applications 270 of the selection in a visible mode permitting both an iconic representation of each corresponding application to be visible in a user interface of the display 250 and also a default consumption of computing resources of the pervasive device 200. The program code even further is enabled to deny default visibility and resource utilization for those of the applications 270 excluded from the selection.

In even yet further illustration of the operation of the contextual utilization module 300, FIG. 3 is a flow chart illustrating a process for contextual application utilization management in a pervasive device. Beginning in block 310, it can be determined whether or not the pervasive device has been placed into a context mode or a non-context mode. In decision block 320, if it is determined that the pervasive device is in a non-context mode, the process ends in block 330. Otherwise, the process continues through block 340. In block 340, an environmental context can be determined for the pervasive device. For instance, a current time, date, location or weather condition can be determined for the pervasive device and matched to a saved environmental context. The environmental context can be specified explicitly by the end user, or the environmental context can be determined in an automated fashion.

In this regard, in connection with the current date, the current season (winter, spring summer, fall) can be determined. As well, the environmental context can include data determined by device sensors, such as temperature or humidity. The environmental context yet further can include detected nearby devices or individuals by way of location based services or wireless communications and sensing such as near field communications, Bluetooth or radio frequency identification. Even further, the environmental context can include instrumented data received from devices or individuals in proximity to the pervasive device such as data emitted from a water meter or electric meter. Finally, the environmental context may include biometric data received from an individual utilizing the pervasive device such as heart rate, or hydration levels.

Thereafter, in block 350 one or more applications installed in the pervasive device can be selected based upon an annotation matching the determined environmental context. In block 360, those of the applications included in the selection can be rendered visible in a user interface to the pervasive device and granted access to the computing resources of the pervasive device. Conversely, in block 370 those of the applications excluded from the selection can be blocked from default visibility in the user interface of the pervasive device and, optionally denied access to the computing resources.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method of contextual application utilization management in a pervasive device, the method comprising:
annotating different applications in a pervasive device with different context associations for respectively different environmental contexts of the pervasive device;
activating a context mode in the pervasive device; and,
responsive to the activation of the context mode, determining a contemporaneous environmental context for the pervasive device, selecting individual ones of the different applications having associated context annotations matching the determined contemporaneous environmental context, and blocking default utilization of resources of the pervasive device by unselected ones of the different applications while permitting default utilization of the resources of the pervasive device by selected ones of the different applications.

2. The method of claim 1, wherein the different environmental contexts of the pervasive device include a location of the pervasive device.

3. The method of claim 1, wherein the different environmental contexts of the pervasive device include a date or time.

4. The method of claim 1, wherein the different environmental contexts of the pervasive device include a weather condition at a location of the pervasive device.

5. The method of claim 1, wherein the blocking of default utilization includes blocking access to computing resources of the pervasive device.

6. The method of claim 1, wherein the blocking of default utilization includes removing icons for the unselected ones of the different applications in a user interface of the pervasive device.

7. The method of claim 1, further comprising:
detecting a change in contemporaneous environmental context for the pervasive device; and,
responsive to the detection of the changed contemporaneous environmental context, selecting individual ones of the different applications having associated context annotations matching the changed contemporaneous environmental context, and blocking default utilization of resources of the pervasive device by unselected ones of the different applications while permitting default utilization of the resources of the pervasive device by selected ones of the different applications.

8. A pervasive device data processing system configured for contextual application utilization management, the system comprising:
a pervasive device comprising at least one processor coupled to memory;
a wireless network adapter adapted to transceive data in the memory wirelessly over a communications network;
a plurality of applications stored in persistent storage of the pervasive device and coupled to the processor and memory, each of the applications comprising an annotation specifying at least one environmental context; and,
a contextual application utilization management module comprising program code enabled upon execution in the memory of the pervasive device to activate a context mode for the pervasive device and in response to the activation of the context mode, to determine a contemporaneous environmental context for the pervasive device, to select individual ones of the different applications having associated context annotations matching the determined contemporaneous environmental context, and to block default utilization of resources of the pervasive device by unselected ones of the different applications but to permit default utilization of the resources of the pervasive device by the selected ones of the different applications.

9. The system of claim 8, wherein the different environmental contexts of the pervasive device include a location of the pervasive device.

10. The system of claim 8, wherein the different environmental contexts of the pervasive device include a date or time.

11. The system of claim 8, wherein the different environmental contexts of the pervasive device include a weather condition at a location of the pervasive device.

12. The system of claim 8, wherein the blocking utilization includes blocking access to computing resources of the pervasive device.

13. The system of claim 8, wherein the blocking utilization includes removing access to icons for the unselected ones of the different applications in a user interface of the pervasive device.

14. A computer program product for contextual application utilization management in a pervasive device, the computer program product comprising a computer readable storage medium having program instructions embodied therewith, the program instructions executable by the pervasive device to cause the pervasive device to perform a method comprising:
annotating different applications in a pervasive device with different context associations for respectively different environmental contexts of the pervasive device;
activating a context mode in the pervasive device; and,
responsive to the activation of the context mode, determining a contemporaneous environmental context for the pervasive device, selecting individual ones of the different applications having associated context annotations matching the determined contemporaneous environmental context, and blocking utilization of resources of the pervasive device by unselected ones of the different applications while permitting default utilization of the resources of the pervasive device by selected ones of the different applications.

15. The computer program product of claim 14, wherein the different environmental contexts of the pervasive device include a location of the pervasive device.

16. The computer program product of claim 14, wherein the different environmental contexts of the pervasive device include a date or time.

17. The computer program product of claim 14, wherein the different environmental contexts of the pervasive device include a weather condition at a location of the pervasive device.

18. The computer program product of claim 14, wherein the blocking utilization includes blocking access to computing resources of the pervasive device.

19. The computer program product of claim 14, wherein the blocking utilization includes removing access to icons for the unselected ones of the different applications in a user interface of the pervasive device.

20. The computer program product of claim 14, wherein the method further comprises:
detecting a change in contemporaneous environmental context for the pervasive device; and,
responsive to the detection of the changed contemporaneous environmental context, selecting individual ones of the different applications having associated context annotations matching the changed contemporaneous environmental context, and blocking default utilization of resources of the pervasive device by unselected ones of the different applications while permitting default utilization of the resources of the pervasive device by selected ones of the different applications.
